(19) United States
(12) Patent Application Publication
(10) Pub. No.: US 2017/0069071 A1
(43) Pub. Date: Mar. 9, 2017

(54) APPARATUS AND METHOD FOR EXTRACTING PERSON REGION BASED ON RED/GREEN/BLUE-DEPTH IMAGE

(71) Applicant: ELECTRONICS AND TELECOMMUNICATIONS RESEARCH INSTITUTE, Daejeon (KR)

(72) Inventor: Sung Uk Jung, Daejeon (KR)

(21) Appl. No.: 15/006,630

(22) Filed: Jan. 26, 2016

(30) Foreign Application Priority Data
Sep. 4, 2015 (KR) 10-2015-0125417

(51) Int. Cl. G06T 7/00

(52) U.S. Cl. CPC G06T 7/002; G06T 7/0081; G06T 2207/20124; G06T 2207/10024; G06T 2207/10028; G06T 2207/20144; G06T 2207/20024

(57) ABSTRACT

An apparatus for extracting a person region based on a red/green/blue-depth (RGB-D) image includes a data input unit configured to match an input RGB image and depth image and output matched RGB-D image data, a region-of-interest (ROI) extractor configured to remove a background image from the matched RGB-D image data from the data input unit, extract an approximate region of a person from an image obtained by removing the background image, and extract an ROI by applying a preset three-dimensional (3D) human model to the approximate person region, a depth information corrector configured to analyze the degree of similarity between the matched RGB image and depth image for the ROI extracted by the ROI extractor and correct the depth image, and a person region extractor configured to extract a person region from the depth image corrected by the depth information corrector.

### CROSS-REFERENCE TO RELATED APPLICATION

This application claims priority to and the benefit of Korean Patent Application No 10-2015-0125417, filed on Sep. 4, 2015, the disclosure of which is incorporated herein by reference in its entirety.

### BACKGROUND

1. Field of the Invention

The present invention relates to an apparatus and method for extracting a person region based on a red/green/blue-depth (RGB-D) image, and more particularly, to an apparatus and method for extracting a person region based on an RGB-D image which are intended to accurately separate the person region from a background according to relevant technology for recognizing an object based on depth information of space and the object using an RGB-D (color depth) device.

2. Discussion of Related Art

In general, a segmentation technique for separating an object from a background image is a main technique which is fundamental in the fields of virtual reality and augmented reality.

Methods of separating a person region from a background image can be roughly classified into a method in which only color (RGB) information input from a camera according to an input source is used and a method in which a multi-channel input source (color and depth information, etc.) is used.

To separate a person region from a background image using the method in which only color information is used, basic information of a person (a skeleton, a color, a three-dimensional (3D) human model, etc.) is used in a still image, or a method of extracting motion information using time difference between images and separating a moving object is used.

In the other method in which multiple sources are used, absolute values, etc. input using color information, other input sources (e.g., depth information, temperature information), etc. are compared to separate a person region from a background image.

However, in the case of the method of separating a person region using only color information, it is not easy to accurately separate a person according to lighting and pose information of the person.

The method in which multiple sources are used has a merit in that it is robust to lighting. However, basically, there is a loss of data input from the multiple sources due to surroundings, and it is difficult to precisely separate a person region due to inaccurate matching between the data and color information.

### SUMMARY OF THE INVENTION

The present invention is directed to providing an apparatus and method for extracting a person region based on a red/green/blue-depth (RGB-D) image which precisely separate a person region from a background image by analyzing similarity between multiple sources, that is, color and depth information.

According to an aspect of the present invention, there is provided an apparatus for extracting a person region based on an RGB-D image, the apparatus including: a data input unit configured to match an input RGB image and depth image and output matched RGB-D image data; a region-of-interest (ROI) extractor configured to remove a background image from the matched RGB-D image data output from the data input unit, extract an approximate region of a person from an image obtained by removing the background image, and extract an ROI by applying a preset three-dimensional (3D) human model to the approximate person region; a depth information corrector configured to analyze a degree of similarity between the matched RGB image and depth image for the ROI extracted by the ROI extractor and correct the depth image; and a person region extractor configured to extract a person region from the depth image corrected by the depth information corrector.

The data input unit may determine whether there are intrinsic parameters of cameras when the RGB image and the depth image are input, extract identical points between the two images when it is determined that there are intrinsic parameters of two cameras, calculate an image matching relationship by matching the extracted identical points, and then synchronize the two images according to the calculated matching relationship.

To synchronize the two images, the data input unit may calculate positions of corresponding points between the two images as a result dependent on whether there are intrinsic parameters of the cameras, and synchronize the RGB image and the depth image having an identical size and in which corresponding pixels are at identical positions based on one of the two images having a lower resolution.

When it is determined that there are no intrinsic parameters of the cameras, the data input unit may extract identical points between the RGB image and the depth image, calculate an image matching relationship by matching the extracted identical points, calculate a two-dimensional (2D) homography matrix according to the calculated matching relationship, and then synchronize the two images.

The ROI extractor may remove the background image from the matched RGB image and depth image using image motion information between frames of the RGB-D image data matched by the data input unit, calculate respective contours for the foreground image obtained by removing the background image to group the contours, project data of the contours to x and y axes to designate a region with a bounding box, and extract skeleton information from the bounding box region to extract the ROI.

The ROI extractor may match a preset cylindrical 3D model to a 3D position of the extracted skeleton information and extract a region of the matched cylindrical 3D model as the ROI estimated to contain the person.

The depth information corrector may divide matched RGB image data corresponding to matched depth image data into ROI patches, analyze degrees of image template similarity of the divided ROI patches to correct patch-specific depth data, integrate the patches whose depth data has been corrected, and remove data noise to correct the depth image by performing post processing, such as Gaussian filtering, for edges of the integrated patches.

The depth information corrector may analyze the degrees of image template similarity using a colorization method of Anat Levin.

When the RGB-D image data whose depth data has been corrected is input, the person region extractor may divide the ROI extracted by the ROI extractor into groups based on 3D distance, remove invalid groups using skeleton information to find a valid group, extract pixels of the RGB image corresponding to grouped depth data values, and extract an RGB region of the person from the original image using the extracted RGB pixels.

The person region extractor may divide the ROI into the groups using a K-means clustering method.

According to another aspect of the present invention, there is provided a method of extracting a person region based on an RGB-D image, the method including: matching an input RGB image and depth image into RGB-D image data; removing a background image from the matched RGB-D image data, extracting an approximate region of a person from a foreground image obtained by removing the background image, and extracting an ROI by applying a preset 3D human model to the approximate person region; analyzing a degree of similarity between the matched RGB image and depth image for the extracted ROI and correcting the depth image; and extracting a person region from the corrected depth image.

The matching of the input RGB image and depth image may include: determining whether there are intrinsic parameters of cameras when the RGB image and the depth image are input; when it is determined that there are intrinsic parameters of two cameras, extracting identical points between the two images and calculating an image matching relationship by matching the extracted identical points; and synchronizing the two images according to the calculated matching relationship to match the two images.

The synchronizing of the two images may include: calculating positions of corresponding points between the two images according to whether there are intrinsic parameters of the cameras; and synchronizing the RGB image and the depth image having an identical size and in which corresponding pixels are at identical positions based on one of the two images having a lower resolution.

The matching of the input RGB image and depth image may further include: when it is determined that there are no intrinsic parameters of the cameras, extracting identical points between the RGB image and the depth image; and calculating an image matching relationship by matching the extracted identical points, calculating a 2D homography matrix according to the calculated matching relationship, and then synchronizing the two images.

The extracting of the ROI may include: removing the background image from the matched RGB image and depth image using image motion information between frames of the matched RGB-D image data; calculating respective contours for the foreground image obtained by removing the background image, and grouping the contours; projecting data of the grouped contours to x and y axes to designate a region with a bounding box; and extracting skeleton information from the bounding box region to extract the ROI.

The extracting of the ROI may include matching a preset cylindrical 3D model to a 3D position of the extracted skeleton information and extracting a region of the matched cylindrical 3D model as the ROI estimated to contain the person.

The correcting of the depth image may include: dividing matched RGB image data corresponding to matched depth image data into ROI patches; analyzing degrees of image template similarity of the divided ROI patches; correcting patch-specific depth data and integrating the patches whose depth data has been corrected; and removing data noise to correct the depth image by performing post processing, such as Gaussian filtering, for edges of the integrated patches.

The analyzing of the degrees of image template similarity may include analyzing the degrees of image template similarity using a colorization method of Anat Levin.

The extracting of the person region may include: when RGB-D image data whose depth data has been corrected is input, dividing the ROI into groups based on 3D distance; removing invalid groups using skeleton information to find a valid group; extracting pixels of the RGB image corresponding to grouped depth data values; and extracting an RGB region of the person from the original image using the extracted RGB pixels.

The dividing of the ROI into the groups may include dividing the ROI into the groups using a K-means clustering method.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a configuration of an apparatus for extracting a person region based on a red/green/blue-depth (RGB-D) image according to an exemplary embodiment of the present invention;

FIGS. 2A to 2H show examples of images obtained in a process of extracting a person region based on an RGB-D image according to an exemplary embodiment of the present invention;

FIG. 3 is a flowchart illustrating a method of extracting a person region based on an RGB-D image according to an exemplary embodiment of the present invention;

FIG. 4 is a detailed flowchart of operation S200 illustrated in FIG. 3;

FIG. 5 is a detailed flowchart of operation S300 illustrated in FIG. 3;

FIG. 6 is a detailed flowchart of operation S400 illustrated in FIG. 3; and

FIG. 7 is a detailed flowchart of operation S500 illustrated in FIG. 3.

### DETAILED DESCRIPTION OF EXEMPLARY EMBODIMENTS

Advantages and features of the present invention and a method of achieving the same will be more clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Throughout the specification, like reference numerals refer to like elements.

In describing the present invention, any detailed description of known technology or function will be omitted if it is deemed that such a description will obscure the gist of the invention unintentionally. The terms used in the following description are terms defined in consideration of functions in exemplary embodiments of the present invention and may vary depending on an intention of a user or an operator, or a practice, etc. Therefore, definitions of terms used herein should be made based on content throughout the specification.

Hereinafter, an apparatus and method for extracting a person region based on a red/green/blue-depth (RGB-D) image according to exemplary embodiments of the present invention will be described in detail with reference to the accompanying drawings.

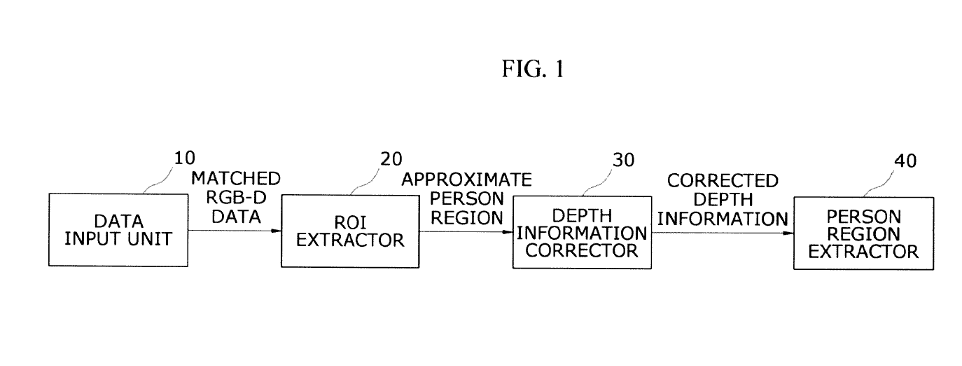

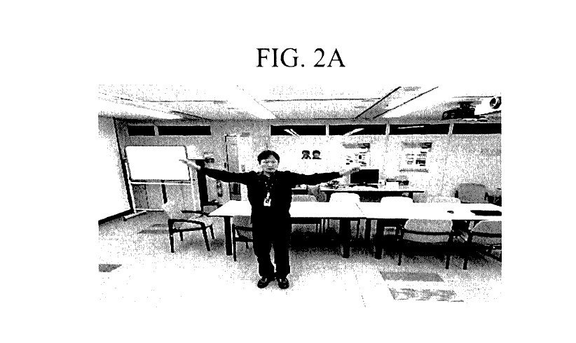

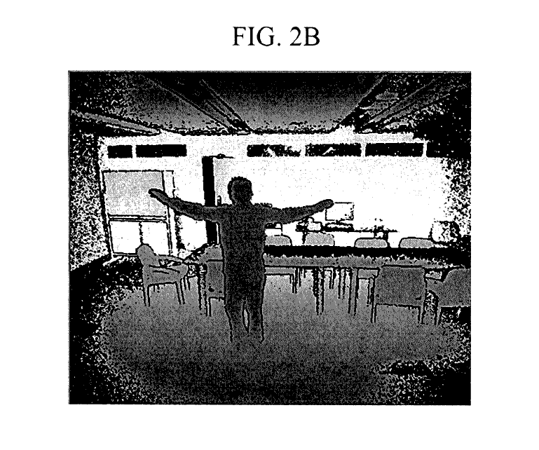

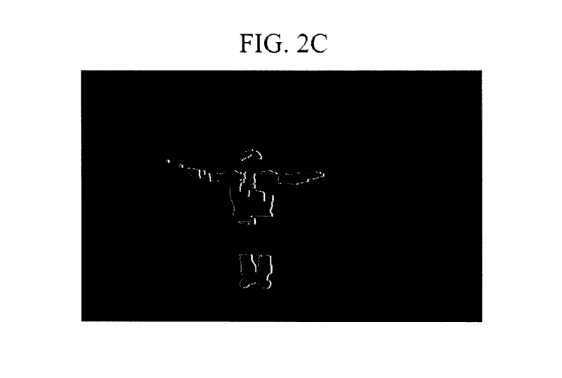

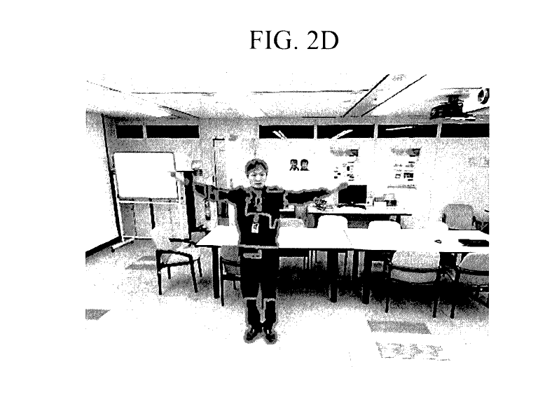

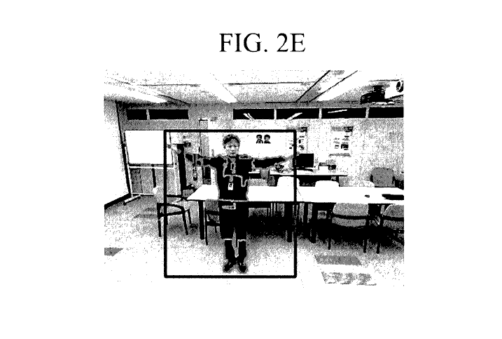

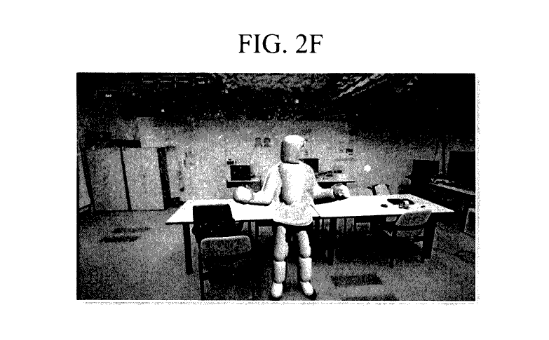

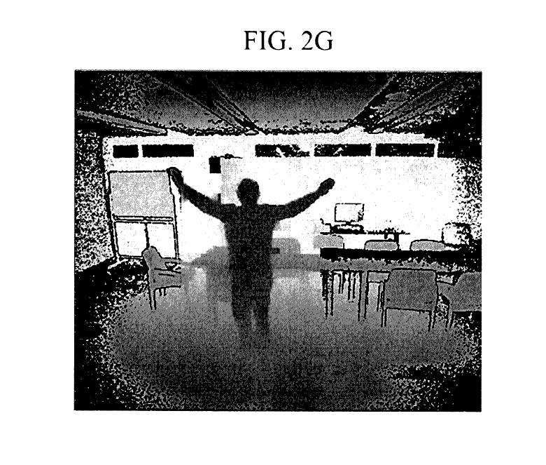

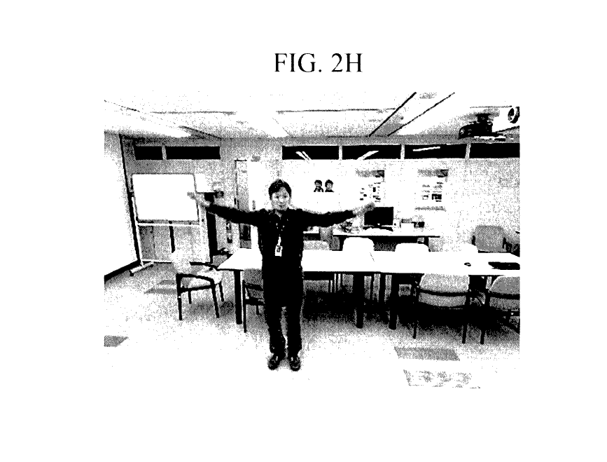

FIG. 1 is a block diagram showing a configuration of an apparatus for extracting a person region based on an RGB-D image according to an exemplary embodiment of the present invention, and FIGS. 2A to 2H show examples of images obtained in a process of extracting a person region based on an RGB-D image according to an exemplary embodiment of the present invention. Here, FIG. 2A shows an original color image, FIG. 2B shows an original depth image, FIG. 2C shows an image obtained by removing a background image from an image in which the images of FIGS. 2A and 2B are matched, FIG. 2D shows an image obtained by grouping contours of a person in the foreground image of FIG. 2C obtained by removing the background image, FIG. 2E shows an image in which a region of interest (ROI) is extracted from the contour grouping image of FIG. 2D through x and y axis projection, FIG. 2F shows an image of a three-dimensional (3D) cylindrical model, FIG. 26 shows an image whose depth information has been corrected by a depth information corrector of FIG. 1, and FIG. 2H shows an image in which a final person region is extracted.

As shown in FIG. 1, the apparatus for extracting a person region based on an RGB-D image according to an exemplary embodiment of the present invention may include a data input unit 10, an ROI extractor 20, a depth information corrector 30, and a person region extractor 40.

The data input unit 10 receives an RGB image and a depth image from respective cameras (or sensors), matches the received two images, and provides the matched RGB-D image data to the ROI extractor 20.

The ROI extractor 20 removes a background image from the matched RGB-D image data provided by the data input unit 10, extracts an approximate region of a person from an image obtained by removing the background image, and extracts an ROI by applying a 3D cylindrical human model to the approximate person region.

For the ROI extracted by the ROI extractor 20, the depth information corrector 30 analyzes the degree of similarity between the matched color (RGB) image and the depth image, and corrects the depth image.

The person region extractor 40 extracts a person region from the depth image corrected by the depth information corrector 30.

A detailed operation of the apparatus for extracting a person region based on an RUB-D image according to an exemplary embodiment of the present invention which has such a configuration will be described below.

First, the RGB image and the depth image input from an RGB camera (or sensor) and a depth camera (or sensor) as shown in FIGS. 2A and 2B are captured by the different cameras. Therefore, when the two images overlap each other, they do not accurately correspond to each other due to their disparity.

Also, when there is a difference in resolution between the two cameras, a function for correcting the resolution difference is necessary. In the case of an input device, for example, Kinect v2, which simultaneously receives a color image and a depth image, the resolution of the color image is 1920×1080 pixels, but the resolution of the depth image is 512×424 pixels. Therefore, a calculation process for calculating which pixel of a depth image corresponds to each pixel of an RGB image is necessary.

Therefore, the data input unit 10 performs a function of adjusting the RGB image and the depth image captured by the different cameras to have the same resolution, and converting the two images so that pixels of the two images correspond to each other. In other words, the data input unit 10 matches the input RGB image and depth image.

A detailed operation of the data input unit 10 matching the RGB image and the depth image will be described below.

First, a multi-source input device generally employs two (color and depth) cameras.

When an RGB image and a depth image as shown in FIGS. 2A and 2B are input from the two cameras, the data input unit 10 may determine whether there are intrinsic parameters of the two cameras. When it is determined that there are intrinsic parameters of the two cameras, the data input unit 10 may calculate rotation information and translation information between the two cameras in a 3D space. Therefore, it is possible to calculate a pixel position of the color image corresponding to each pixel in the depth image. In other words, when the intrinsic parameters of the two cameras are known, the data input unit 10 calculates a pixel matching relationship between the RGB image and the depth image.

On the other hand, when the intrinsic parameters of the two cameras are unknown, the data input unit 10 extracts identical points between the RGB image and the depth image, finds an image matching relationship, that is, at least four corresponding points of the two images (color image and depth image), by matching the extracted identical points, and calculates a two-dimensional (2D) homography matrix using the corresponding points.

In other words, in the above two cases, the positions of corresponding points between the two images can be calculated as a result dependent on whether there are intrinsic parameters of the two cameras. After that, since the two images may have difference in resolution, the data input unit 10 synchronizes the color image and depth image having an identical size and in which corresponding pixels are at identical positions based on one of the two images having a lower resolution, and outputs the matched RGB image and depth image to the ROI extractor 20.

The ROI extractor 20 extracts an approximate region (ROI) in which a person is present from the matched RGB-D image provided by the data input unit 10.

First, the ROI extractor 20 performs a function of receiving a background image and extracting a foreground region. By comparing color distributions based on an initial image, the ROI extractor 20 extracts a newly added part. The extracted foreground image includes a lot of noise data according to surroundings.

Since the foreground extraction is performed based on color data, when the RGB distribution of the background is similar to the RGB distribution of the foreground image, the background is extracted as the foreground. Then, the ROI extractor 20 generates a contour from the extracted foreground data and groups the data. After that, the ROI extractor 20 projects point data constituting the generated contour to x and y axes to generate a bounding box including the contour, thereby extracting the region of the foreground object.

Then, the ROI extractor 20 extracts skeleton information from the extracted region of the foreground object, and matches a preset 3D cylindrical model based on the extracted information, thereby extracting a final ROI.

Referring to the operation of the ROI extractor 20 in stages, the ROI extractor 20 is configured to remove potential noise of a part other than the ROI, that is, the approximate region of the person, and increase a processing rate by extracting the ROI.

First, the ROI extractor 20 receives matched RGB-D image data (FIGS. 2A and 2B) from the data input unit 10, and removes a background image from the matched RGB image and depth image input as shown in FIG. 2C using image motion information between respective frames. Basically, a difference in an RGB image is used in a background removal method. For this reason, when a moving object and a background have similar RGB distributions, the background removal method may not be correctly performed. Therefore, each contour is calculated for the foreground image obtained by removing the background as shown in FIG. 2D. Here, the minimum size of a contour is adjusted to remove little noise and reduce the amount of calculation.

Also, the ROI extractor 20 projects data of contours to the x and y axes to extract an approximate region of the person. Then, a region which is estimated to contain the object (person) is found in the x and y axes, and the ROI extractor 20 designates the region with a bounding box as shown in FIG. 2E.

The ROI extractor 20 extracts skeleton information from the bounding box region designated in this way. The ROI extractor 20 does not determine the bounding box region as a person region when skeleton information is not extracted. On the other hand, when skeleton information is extracted, the ROI extractor 20 matches a preset cylindrical 3D model to the 3D position of the extracted skeleton as shown in FIG. 2F.

The region of the matched cylindrical 3D model is a final 3D person region which is estimated to contain the person. This region is extracted as an ROI, and extracted ROI information is provided to the depth information corrector 30.

For the ROI extracted by the ROI extractor 20, the depth information corrector 30 analyzes the degree of similarity between the matched color (RGB) image and the depth image, and corrects the depth image. Specifically, an RGB-D device (e.g., Kinect v2, etc.) includes a combination of a depth camera and an RGB camera, and generates a point cloud by analyzing input images of these cameras. At this time, depth information may not be extracted due to the shadow of an object according to the position of the object and the disparity between the cameras. Therefore, the depth information corrector 30 analyzes the degree of similarity between the RGB color image and the depth image and corrects a depth hole that is a part from which depth information is not extracted.

Referring to the operation of the depth information corrector 30 in stages, the depth information corrector 30 receives the matched RGB color image and depth image data, analyzes the degree of similarity between the two images, and corrects the depth data. To optimize a processing rate, the depth information corrector 30 divides the color image data corresponding to the depth image data into ROI patches first.

Then, the depth information corrector 30 analyzes the degrees of image template similarity of the divided ROI patches and corrects patch-specific depth data, that is, a depth hole. As a method of analyzing the degrees of image template similarity, a method of comparing two images to find an optimal solution, such as a colorization method of Anat Levin, is used. Since the color image data is divided into the patches, parallel computing is used for the respective patches to increase the processing rate as much as possible.

Subsequently, the depth information corrector 30 recovers one piece of depth data by integrating the processed patches. In the recovered data, data noise may occur at the edges of the patches. Therefore, to remove such data noise, the depth information corrector 30 performs post processing, such as Gaussian filtering, for the edges of the patches, thereby correcting the depth image as shown in FIG. 2G. The depth image corrected in this way is provided to the person region extractor 40.

The person region extractor 40 performs a function of extracting the region of the person based on the depth information corrected by the depth information corrector 30. The person region extractor 40 groups the ROI, that is, the approximate person region, extracted by the ROI extractor 20 and depth information of the corresponding region in the corrected depth information, thereby extracting a precise region of the person.

More specifically, the person region extractor 40 receives the RGB-D image corrected by the depth information corrector 30, and divides depth data of the ROI extracted by the ROI extractor 20 into groups based on the depth data and 3D distance using a method, such as a K-means clustering method and so on. After grouping, the person region extractor 40 removes invalid groups using the skeleton information to find a valid group.

Also, the person region extractor 40 extracts pixels of the color image corresponding to the grouped depth data values.

Then, the person region extractor 40 calculates a pixel region using the extracted color image pixels, and calculates the pixel region as a region in the original image. In other words, the person region extractor 40 extracts an RGB region of the person from the original image using the extracted RGB pixels, so that a person region is extracted as shown in FIG. 2H.

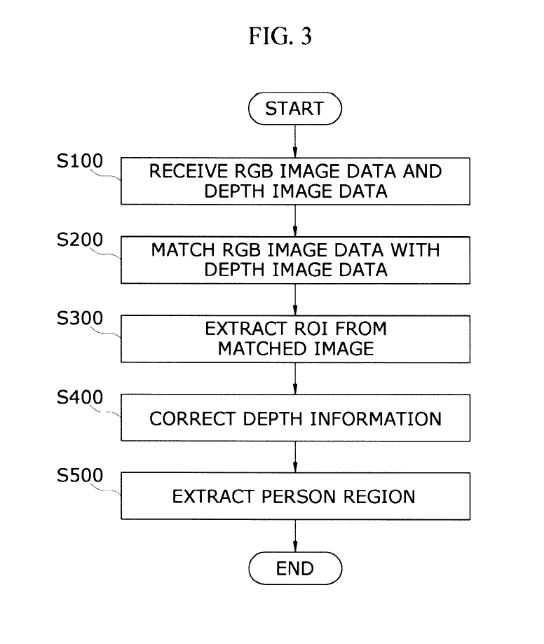

A method of extracting a person region based on an RGB-D image according to an exemplary embodiment of the present invention corresponding to the above-described apparatus for extracting a person region based on an RGB-D image according to an exemplary embodiment of the present invention will be described in stages with reference to FIGS. 3 to 7.

FIG. 3 is a flowchart illustrating a method of extracting a person region based on an RGB-D image according to an exemplary embodiment of the present invention.

First, as shown in FIG. 3, an RGB image and a depth image are received from respective cameras (or sensors) (S100), and the received RGB image and depth image are matched (S200).

Subsequently, a background image is removed from the matched RGB-D image data, an approximate region of a person is extracted from an image obtained by removing the background image, and an ROI is extracted by applying a 3D cylindrical human model as shown in FIG. 2F to the approximate region (S300).

For the extracted ROI, the degree of similarity between the color (RGB) image and the depth image matched in operation S200 is analyzed, and the depth image is corrected (S400).

Then, a person region is extracted from the corrected depth image (S500).

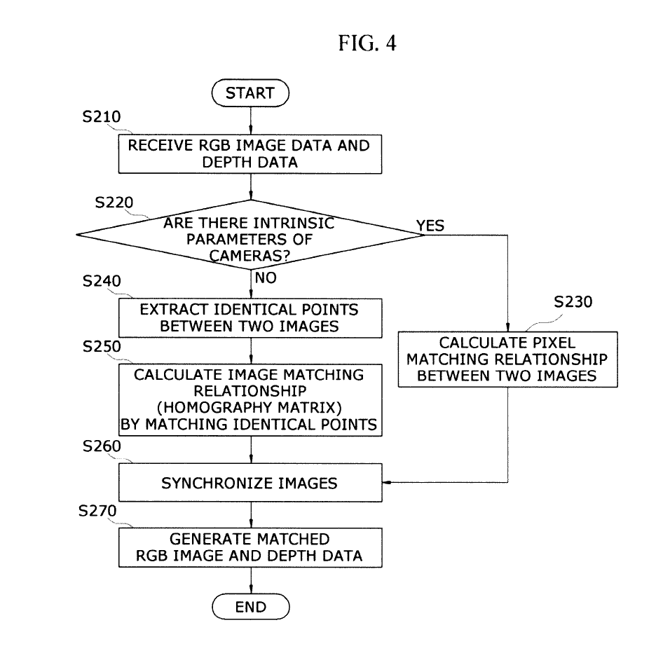

Operations S100 and S200 described above, that is, a method of matching the RGB image data and the depth image data will be described in further detail with reference to FIG. 4.

FIG. 4 is a detailed flowchart of operation S200 illustrated in FIG. 3.

First, as shown in FIG. 4, when the RGB image and the depth image as shown in FIGS. 2A and 2B are received from an RGB camera and a depth camera (S210), it is determined whether there are intrinsic parameters of the cameras (S220).

When it is determined that there are intrinsic parameters of the two cameras, it is possible to calculate rotation information and translation information between the two cameras in a 3D space. Therefore, it is possible to calculate a pixel position of the color image corresponding to each pixel in the depth data. In other words, when the intrinsic parameters of the two cameras are known, a pixel matching relationship between the RGB image and the depth image is calculated (S230).

On the other hand, when it is determined in operation S220 that there are no intrinsic parameters of the two cameras, identical points between the RGB image and the depth image are extracted (S240). Then, the extracted identical points are matched to find an image matching relationship, that is, at least four corresponding points of the two images (color image and depth image), and a 2D homography matrix is calculated using the corresponding points (S250).

After operation S230 or S250, the positions of corresponding points between the two images can be calculated as a result dependent on whether there are intrinsic parameters of the two cameras.

Subsequently, since the two images may have difference in resolution, the color image and depth image having an identical size and in which corresponding pixels are at identical positions are synchronized based on one of the two images having a lower resolution (S260), and the matched RGB image and depth image are generated (S270).

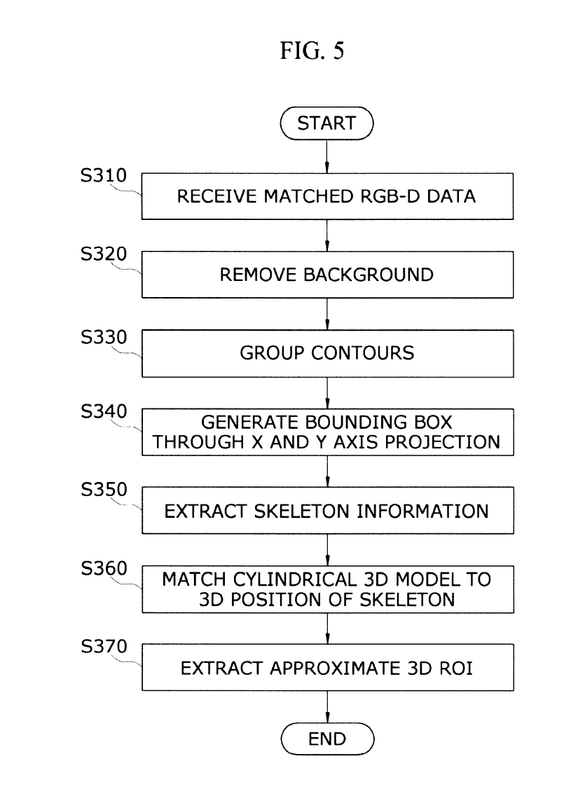

Meanwhile, operation S300 illustrated in FIG. 3, that is, a method of extracting the ROI from the RGB-D image data matched in operation S200 will be described in detail with reference to FIG. 5.

FIG. 5 is a detailed flowchart of operation S300 illustrated in FIG. 3.

As shown in FIG. 5, when the RGB-D image data (see FIGS. 2A and 2B) matched in operation S200 is received (S310), the background is removed from the matched RGB image and depth image as shown in FIG. 2C using image motion information between respective frames (S320).

Basically, a difference in an RGB image is used in the background removal method. For this reason, when the moving object and the background have similar RGB distributions, the background removal method may not be correctly performed. Therefore, respective contours are calculated for a foreground image obtained by removing the background as shown in FIG. 2D and grouped (S330). Here, the minimum size of a contour is adjusted to remove little noise and reduce the amount of calculation.

Subsequently, data of the contours is projected to the x and y axes to extract the approximate region of the person. Then, a region which is estimated to contain the object (person) is found in the x and y axes, and is designed with a bounding box as shown in FIG. 2E (S340).

From the bounding box region designated in this way, skeleton information is extracted (S350). When skeleton information is not extracted, the bounding box region is not determined as a person region. On the other hand, when skeleton information is extracted, a preset cylindrical 3D model is matched to the 3D position of the extracted skeleton as shown in FIG. 2F (S360).

The region of the matched cylindrical 3D model is a final 3D person region which is estimated to contain the person. This region is extracted as the ROI (S370).

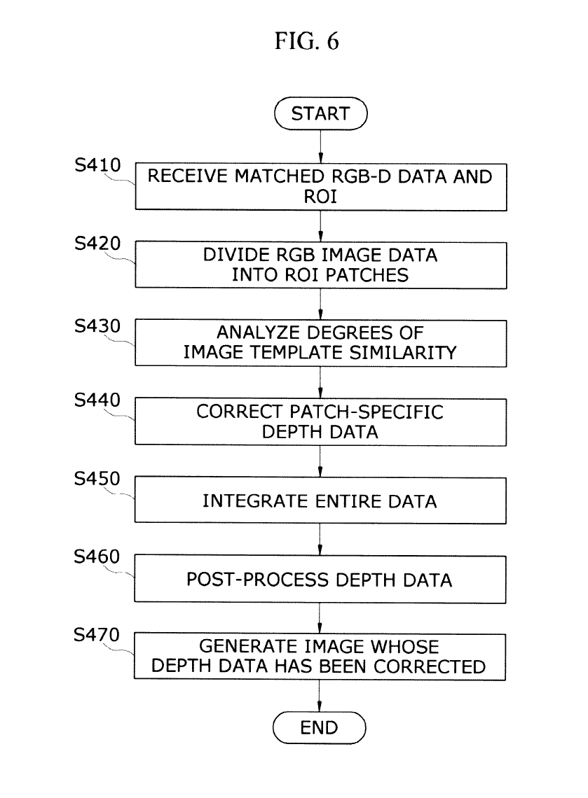

Operation S400 illustrated in FIG. 3, that is, a method of correcting the depth information will be described in stages with reference to FIG. 6.

FIG. 6 is a detailed flowchart of operation S400 illustrated in FIG. 3.

As shown in FIG. 6, the RGB color image and the depth image data matched in operation S200 are received (S410), and the degree of similarity between the two images is analyzed to correct the depth data. To optimize a processing rate, the color image data corresponding to the depth image data is divided into ROI patches first (S420).

Then, the degrees of image template similarity of the divided ROI patches are determined (S430), and patch-specific depth data, that is, a depth hole, is corrected (S440). As a method of analyzing the degrees of image template similarity, a method of comparing two images to find an optimal solution, such as a colorization method of Mat Levin, is used. Since the color image data is divided into the ROI patches, parallel computing is used for the respective patches to increase the processing rate as much as possible.

Subsequently, the processed patches are integrated and recovered as one piece of depth data (S450).

In the recovered data, data noise may occur at the edges of the patches. Therefore, to remove such data noise, post processing, such as Gaussian filtering, is performed for the edges of the patches (S460), and thus an image whose depth data has been corrected is generated as shown in FIG. 2G (S470).

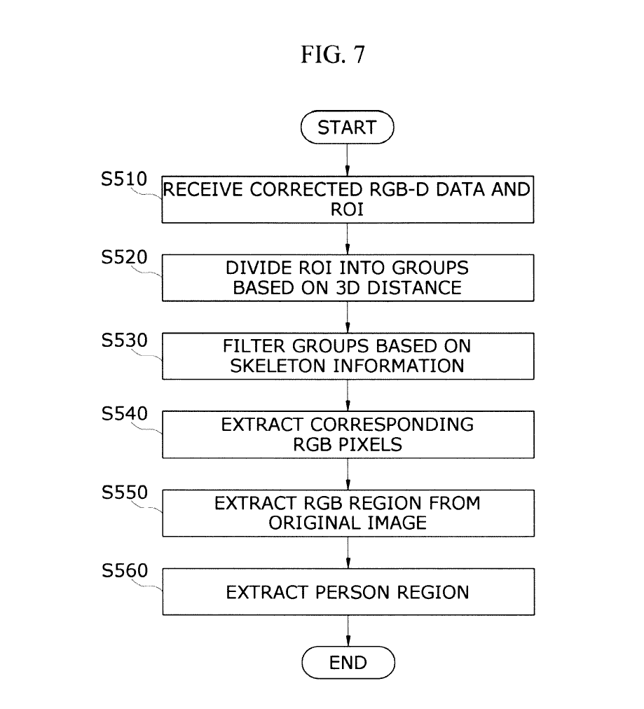

Finally, operation S500 illustrated in FIG. 3, that is, a method of extracting the person region will be described in detail with reference to FIG. 7.

FIG. 7 is a detailed flowchart of operation S500 illustrated in FIG. 3.

As shown in FIG. 7, when the RGB-D image whose depth data has been corrected in operation S400 is received (S510), the depth data of the ROI extracted in operation S300 is divided into groups based on 3D distance using a method, such as a K-means clustering method and so on (S520).

After the extracted ROI is divided into the groups, invalid groups are removed using the skeleton information to find a valid group (S530).

Also, pixels of the color image corresponding to the depth data values grouped in operation S520 are extracted (S540).

Then, a pixel region is calculated using the extracted color image pixels, and the pixel region is calculated as a region in the original image. In other words, an RGB region of the person is extracted from the original image using the extracted RGB pixels (S550), so that the person region is extracted as shown in FIG. 2H (S560).

According to exemplary embodiments of the present invention, a person region is precisely separated from a background image by analyzing the similarity between multiple sources, that is, color and depth information. Therefore, it is possible to precisely separate a person region from virtual space irrespective of lighting and surroundings. Also, by correcting a depth hole, it is possible to precisely recover depth data.

According to exemplary embodiments of the present invention, a virtual studio can be replaced by low-priced equipment in the field of broadcasting and so on.

Exemplary embodiments of the present invention make it possible to precisely express interaction between a virtual object and a person, thereby bringing technology of related fields to greater maturity. Therefore, it is possible to use exemplary embodiments of the present invention in many fields of application.

Although an apparatus and method for extracting a person region based on an RGB-D image are described according to exemplary embodiments, the scope of the present invention is not limited to specific embodiments, and those of ordinary skill in the art can make several alterations, modifications, and variations without departing from the scope of the present invention.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for extracting a person region based on a red/green/blue-depth (RGB-D) image, the apparatus comprising:
a data input unit configured to match an input RGB image and depth image and output matched RGB-D image data;
a region-of-interest (ROI) extractor configured to remove a background image from the matched RGB-D image data output from the data input unit, extract an approximate region of a person from a foreground image obtained by removing the background image, and extract an ROI by applying a preset three-dimensional (3D) human model to the approximate person region,
a depth information corrector configured to analyze a degree of similarity between the matched RGB image and depth image for the ROI extracted by the ROI extractor and correct the depth image; and
a person region extractor configured to extract a person region from the depth image corrected by the depth information corrector.

2. The apparatus of claim 1, wherein the data input unit determines whether there are intrinsic parameters of cameras when the RGB image and the depth image are input, extracts identical points between the two images when it is determined that there are intrinsic parameters of two cameras, calculates an image matching relationship by matching the extracted identical points, and then synchronizes the two images according to the calculated matching relationship.

3. The apparatus of claim 2, wherein, to synchronize the two images, the data input unit calculates positions of corresponding points between the two images as a result dependent on whether there are intrinsic parameters of the cameras, and synchronizes the RGB image and the depth image having an identical size and in which corresponding pixels are at identical positions based on one of the two images having a lower resolution.

4. The apparatus of claim 2, wherein, when it is determined that there are no intrinsic parameters of the cameras, the data input unit extracts identical points between the RGB image and the depth image, calculates an image matching relationship by matching the extracted identical points, calculates a two-dimensional (2D) homography matrix according to the calculated matching relationship, and then synchronizes the two images.

5. The apparatus of claim 1, wherein the ROI extractor removes the background image from the matched RGB image and depth image using image motion information between frames of the RGB-D image data matched by the data input unit, calculates respective contours for the foreground image obtained by removing the background image to group the contours, projects data of the contours to x and y axes to designate a region with a bounding box, and extracts skeleton information from the bounding box region to extract the ROI.

6. The apparatus of claim 5, wherein the ROI extractor matches a preset cylindrical 3D model to a 3D position of the extracted skeleton information and extracts a region of the matched cylindrical 3D model as the ROI estimated to contain the person.

7. The apparatus of claim 1, wherein the depth information corrector divides matched RGB image data corresponding to matched depth image data into ROI patches, analyzes degrees of image template similarity of the divided ROI patches to correct patch-specific depth data, integrates the patches whose depth data has been corrected, and removes data noise to correct the depth image by performing post processing, such as Gaussian filtering, for edges of the integrated patches.

8. The apparatus of claim 7, wherein the depth information corrector analyzes the degrees of image template similarity using a colorization method of Mat Levin.

9. The apparatus of claim 1, wherein, when the RGB-D image data whose depth data has been corrected is input, the person region extractor divides the ROI extracted by the ROI extractor into groups based on 3D distance, removes invalid groups using skeleton information to find a valid group, extracts pixels of the RGB image corresponding to grouped depth data values, and extracts an RGB region of the person from the original image using the extracted RGB pixels.

10. The apparatus of claim 9, wherein the person region extractor divides the ROI into the groups using a K-means clustering method.

11. A method of extracting a person region based on a red/green/blue-depth (RGB-D) image, the method comprising:
matching an input RGB image and depth image into RGB-D image data;
removing a background image from the matched RGB-D image data, extracting an approximate region of a person from a foreground image obtained by removing the background image, and extracting a region-of-interest (ROI) by applying a preset three-dimensional (3D) human model to the approximate person region;
analyzing a degree of similarity between the matched RGB image and depth image for the extracted ROI and correcting the depth image; and
extracting a person region from the corrected depth image.

12. The method of claim 11, wherein the matching of the input RGB image and depth image comprises:
determining whether there are intrinsic parameters of cameras when the RGB image and the depth image are input;
when it is determined that there are intrinsic parameters of two cameras, extracting identical points between the two images and calculating an image matching relationship by matching the extracted identical points; and
synchronizing the two images according to the calculated matching relationship to match the two images.

13. The method of claim 12, wherein, the synchronizing of the two images comprises:
calculating positions of corresponding points between the two images according to whether there are intrinsic parameters of the cameras; and
synchronizing the RGB image and the depth image having an identical size and in which corresponding pixels are at identical positions based on one of the two images having a lower resolution.

14. The method of claim 12, wherein the matching of the input RGB image and depth image further comprises:
when it is determined that there are no intrinsic parameters of the cameras, extracting identical points between the RGB image and the depth image;
calculating an image matching relationship by matching the extracted identical points, calculating a two-dimensional (2D) homography matrix according to the calculated matching relationship, and then synchronizing the two images.

15. The method of claim 11, wherein the extracting of the ROI comprises:
removing the background image from the matched RGB image and depth image using image motion information between frames of the matched RGB-D image data;
calculating respective contours for the foreground image obtained by removing the background image, and grouping the contours;
projecting data of the grouped contours to x and y axes to designate a region with a bounding box; and
extracting skeleton information from the bounding box region to extract the ROI.

16. The method of claim 15, wherein the extracting of the ROI comprises matching a preset cylindrical 3D model to a 3D position of the extracted skeleton information and extracting a region of the matched cylindrical 3D model as the ROI estimated to contain the person.

17. The method of claim 11, wherein the correcting of the depth image comprises:
dividing matched RGB image data corresponding to matched depth image data into ROI patches;
analyzing degrees of image template similarity of the divided ROI patches;
correcting patch-specific depth data and integrating the patches whose depth data has been corrected; and
removing data noise to correct the depth image by performing post processing, such as Gaussian filtering, for edges of the integrated patches.

18. The method of claim 17, wherein the analyzing of the degrees of image template similarity comprises analyzing the degrees of image template similarity using a colorization method of Anat Levin.

19. The method of claim 11, wherein the extracting of the person region comprises:
when RGB-D image data whose depth data has been corrected is input, dividing the ROI into groups based on 3D distance;
removing invalid groups using skeleton information to find a valid group;
extracting pixels of the RGB image corresponding to grouped depth data values; and
extracting an RGB region of the person from the original image using the extracted RGB pixels.

20. The method of claim 19, wherein dividing of the ROI into the groups comprises dividing the ROI into the groups using a K-means clustering method.
